(19) United States
(12) Patent Application Publication
(10) Pub. No.: US 2009/0256762 A1
(43) Pub. Date: Oct. 15, 2009

(54) RFID ANTENNA WITH QUARTER WAVELENGTH SHUNT

(75) Inventor: Thomas Craig Weakley, Simpsonville, SC (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY, INC., Quakertown, PA (US)

(21) Appl. No.: 12/131,274

(22) Filed: Jun. 2, 2008

Related U.S. Application Data
(60) Provisional application No. 61/043,681, filed on Apr. 9, 2008.

(51) Int. Cl. H01Q 1/00

(52) U.S. Cl. 343/722

(57) ABSTRACT

An RFID antenna can include a shunt across a connector region of a length in a range of 1/6 to 1/3 of the operating wavelength of the RFID antenna. This can improve the operating characteristics of the RFID antenna.

### CLAIM OF PRIORITY

This application claims priority to U.S. Provisional Application No. 61/043,681 entitled “RFID ANTENNA WITH QUARTER WAVELENGTH SHUNT” filed Apr. 9, 2008, which is incorporated herein by reference (Atty. Docket No. RCDT-01017US0).

### BACKGROUND

Radio-frequency identification (RFID) is an identification method, relying on storing and remotely retrieving data using devices called RFID tags.

An RFID tag is an object that can be applied to or incorporated into a product for the purpose of identification using radio waves. Such tags can be read from several meters away and beyond the line of sight of the reader.

Most RFID tags contain two main parts. An integrated circuit is used for storing and processing information, modulating and demodulating a (RF) signal and can also be used for other specialized functions. An antenna is used for receiving and transmitting the signal.

### BRIEF DISCUSSION OF THE DRAWINGS

FIG. 1A is a diagram that shows an exemplary antenna design of one embodiment.

FIG. 1B is a graph that shows the transfer characteristics of the antenna design of FIG. 1A.

FIG. 2A shows an exemplary antenna design that uses a quarter wavelength shunt of one embodiment of the present invention.

FIG. 2B shows the transfer characteristics of the antenna design of FIG. 2A.

### DETAILED DESCRIPTION

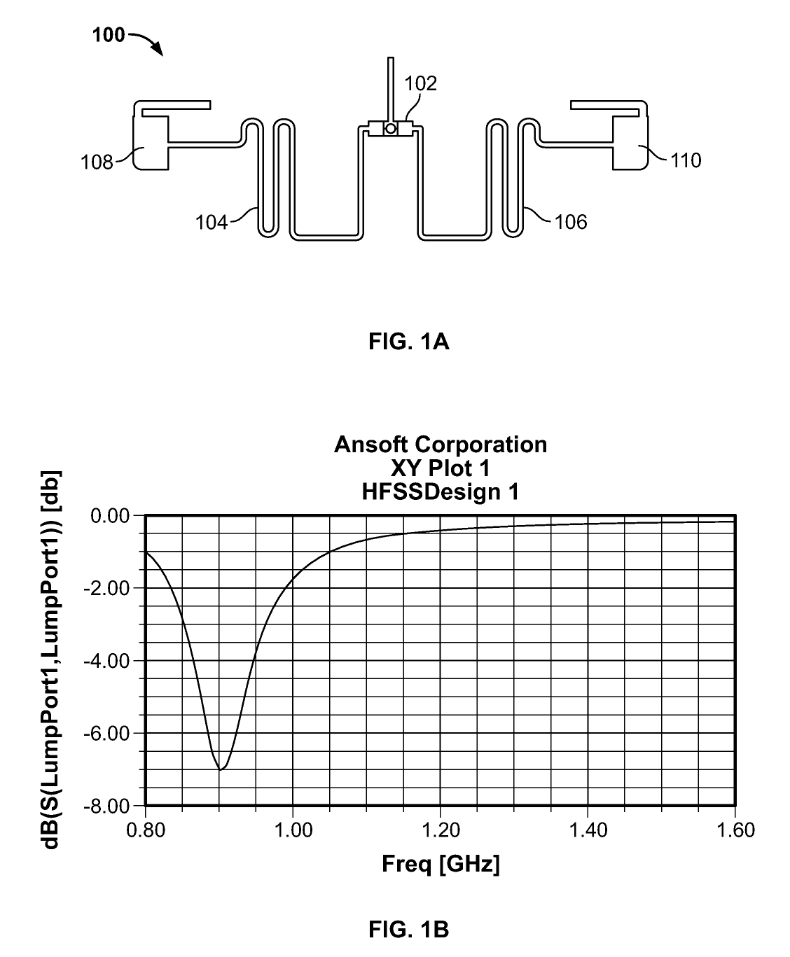

FIG. 1A shows an RFID antenna 100. The RFID antenna 100 includes a connector region 102 for connection to an RFID chip (not shown). In this example, main antenna portions 104 and 106 are on both sides of the connector region 102. The main antenna portion can be meandering lines to keep the size of the RFID antenna relatively small. The main antenna portion 104 and 106 can be attached to capacitive loading elements 108 and 110.

FIG. 1B shows the transfer characteristics of the antenna of FIG. 1A.

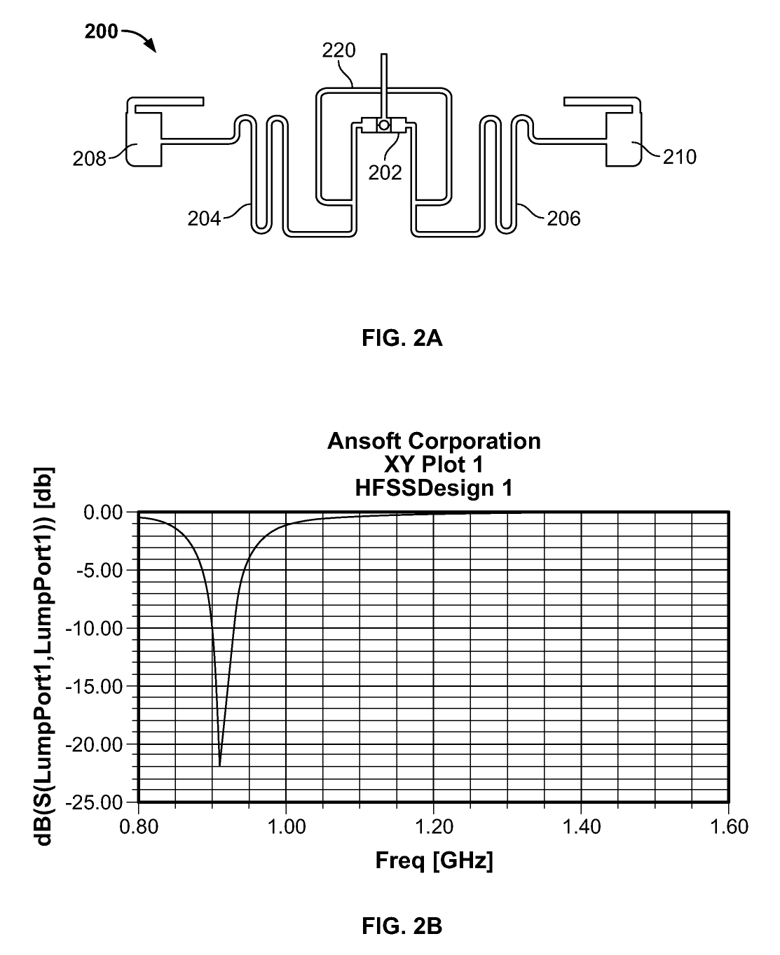

FIG. 2A shows an example with a quarter wavelength shunt. The use of a quarter wavelength shunt can improve the transfer character of the antenna as shown in FIG. 2B.

Previous shunts used with RFID antennas have not been a significantly large percentage of the operating wavelength of the antenna. These shunts have been for ESD protection of the chip but because of their small length have not transferred much energy at the operating frequency of the RFID antenna.

The larger shunts of the present invention do transfer significant energy at the operating frequency and have been determined to improve the characteristics of the RFID antenna.

FIG. 2A shows an RFID antenna 200 that uses a shunt 220. In one embodiment, an RFID antenna 200 comprises a connector region 202 for connecting to an RFID chip (not shown). Main antenna portions 204 and 206 are on two sides of the connector region 202. A shunt 220 is across the connector region 202.

In one embodiment, the shunt 220 is of length in a range of ⅙ to ⅓ of the operating wavelength of the RFID antenna 200. In one embodiment, the shunt has a length about ¼ the operating wavelength of the RFID antenna 200. Shunts away from the quarter wavelength can also have improved characteristics.

The main antenna portion 204 and 206 can be meandering lines. Capacitive loading elements 208 and 210 can be connected to the main antenna portion 204 and 206.

The shunt 220 can be a quarter wavelength shunt.

The shunt 220 across the connector region can be such that the length is a significant large percentage of the operating wavelength of the RFID antenna. In one embodiment, the shunt 220 can have a length greater than 1/12 of the operating wavelength.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. An RFID antenna comprising:
a connector region for connecting to an RFID chip;
main antenna portions on two sides of the connector region; and
a shunt across the connector region of a length in a range of ⅙ to ⅓ of the operating wavelength of the RFID antenna.

2. The RFID antenna of claim 1, wherein the shunt has a length about ¼ the operating wavelength of the RFID antenna.

3. The RFID antenna of claim 1, wherein the main antenna portion are meandering lines.

4. The RFID antenna of claim 1, further comprising capacitive loading elements connected to the main antenna portion.

5. An RFID antenna comprising:
a connector region for connecting to an RFID chip;
main antenna portions on two sides of the connector region; and
a quarter wavelength shunt across the connector region.

6. The RFID antenna of claim 5, wherein the main antenna portion are meandering lines.

7. The RFID antenna of claim 5, further comprising capacitive loading elements connected to the main antenna portion.

8. An RFID antenna comprising:
a connector region for connecting to an RFID chip;
main antenna portions on two sides of the connector region; and
a shunt across the connector region that has a length that is a significantly large percentage of the operating wavelength of the RFID antenna.

9. The antenna of claim 8, wherein the shunt has a length greater than 1/12 of the wavelength.

10. The antenna of claim 9, wherein the shunt has a length in a range of ⅙ to ⅓ the operating wavelength.

11. The RFID antenna of claim 10, wherein the shunt has a length about ¼ the operating wavelength of the RFID antenna.

12. The RFID antenna of claim 8, wherein the main antenna portion is a meandering line. 13. The RFID antenna of claim 8, further comprising capacitive loading elements connected to the main antenna portion.
